(19) United States
(12) Patent Application Publication
(10) Pub. No.: US 2008/0176729 A1
(43) Pub. Date: Jul. 24, 2008

(54) Cutting and folding assembly for products such as tissues, napkins and the like

(75) Inventors: Stefano Anelli, Lucca (IT); Simone Chelossi, Lucca (IT)

Correspondence Address: MODIANO & ASSOCIATI, Via Meravigli, 16, MILAN, 20123, omitted

(73) Assignee: S-TECH S.R.L.

(21) Appl. No.: 11/730,782

(22) Filed: Apr. 4, 2007

(30) Foreign Application Priority Data
Apr. 14, 2006 (IT) BO2006A000293

(51) Int. Cl. B31F 1/10; B31F 7/00

(52) U.S. Cl. 493/360

(57) ABSTRACT

A cutting and folding assembly for sheet products of the multiple-ply type, comprising at least one rotatably supported first roller with cutting blades for cutting the continuous ribbon substantially transversely, associated with a rotary actuation; at least one rotatably supported second roller, associated with a rotary actuation, the second roller provided with a first retention suction for the products cut; and at least one third rotatably supported folding roller, that has a rotary actuation and a second retention suction for cut products, the first, second and third rollers having parallel axes and being in contact along respective generatrices, the second roller being provided with a pressure generation element for generating pressure on the back of the products to keep their plies in contact with the third roller during the formation of the transverse fold.

The present invention relates to a cutting and folding assembly for sheet products, such as tissues, napkins and the like.

### BACKGROUND OF THE INVENTION

In the field of the production of tissues, napkins and the like, particularly made of paper, cutting and folding assemblies are used which comprise parallel rollers which are in mutual contact substantially along their generatrices and through which at least one continuous ribbon, preferably folded longitudinally according to a predefined configuration, passes.

At least one of the rollers is provided with a plurality of transverse cutting blades: the cut products are conveyed from one roller to the other by way of suitable surface retention means and are finally made to abut against one or more fixed plates, which provide one or more transverse folds in said products in preset positions.

Cutting and folding assemblies of the type described here, however, are not free from drawbacks, particularly as regards paper products constituted by several plies. In the passage of the products from one roller to the other, in fact, the outermost plies, i.e., the ones that are not in direct contact with the surface of the rollers and therefore with the retention means, tend to separate from the roller, altering the ordered configuration of the product and thus compromising the correct formation of the fold.

### SUMMARY OF THE INVENTION

The aim of the present invention is to obviate the above-mentioned drawback, by providing a cutting and folding assembly for sheet products, such as tissues, napkins and the like which, particularly but not exclusively with reference to products constituted by a large number of plies, allows to keep said products, during the formation of transverse folds, in a correct configuration, avoiding the separation of the outermost plies.

Within this aim, an object of the present invention is to provide an assembly which is simple, relatively easy to provide in practice, safe in use, effective in operation, and has a relatively low cost.

This aim and this and other objects which will become better apparent hereinafter are achieved by the present cutting and folding assembly for sheet products, such as tissues, napkins and the like, particularly of the multiple-ply type, formed starting from at least one continuous ribbon, characterized in that it comprises: at least one first roller, which is supported so that it can rotate by fixed parts of the production line, is associated with rotary actuation means, and is provided, along its outer surface, with a plurality of blades for cutting the continuous ribbon substantially transversely; at least one second roller, which is supported so that it can rotate by fixed parts of the production line, is associated with rotary actuation means, whose axis is parallel to the axis of said first roller and is substantially in contact with said first roller along a generatrix, said second roller being provided, on its outer surface, with first means for retaining by suction the products cut by said first roller; and at least one third folding roller, which is supported so that it can rotate by fixed parts of the production line and is associated with rotary actuation means, with an axis which is parallel to the axes of said first and second rollers, substantially in contact with said second roller along a generatrix, said third roller being provided, on its outer surface, with second means for retaining the cut products by suction and being associated with at least one fixed abutment, which is adapted to provide at least one transverse fold in each of the cut products, said second roller being further provided with means for generating pressure on the back of each of said products so as to keep all their plies in contact with said third roller during the formation of said fold.

### BRIEF DESCRIPTION OF THE DRAWINGS

Further characteristics and advantages of the invention will become better apparent from the following detailed description of a preferred but not exclusive embodiment of a cutting and folding assembly for products such as tissues, napkins and the like, according to the invention, illustrated by way of non-limiting example in the accompanying drawings, wherein:

FIG. 1 is a perspective view of the cutting and folding assembly according to the invention;

FIG. 2 is a front view of the assembly;

FIG. 3 is a side elevation view of the assembly according to the invention;

FIG. 4 is a detail front view of the suction retention means and of the pressure generation means;

FIG. 5 is a detail side elevation view of the suction retention means and pressure generation means.

### DESCRIPTION OF THE PREFERRED EMBODIMENTS

In the exemplary embodiment that follows, individual characteristics may actually be interchanged with other different characteristics that exist in other exemplary embodiments.

Moreover, it is noted that anything found to be already known during the patenting process is understood not to be claimed and to be the subject of a disclaimer.

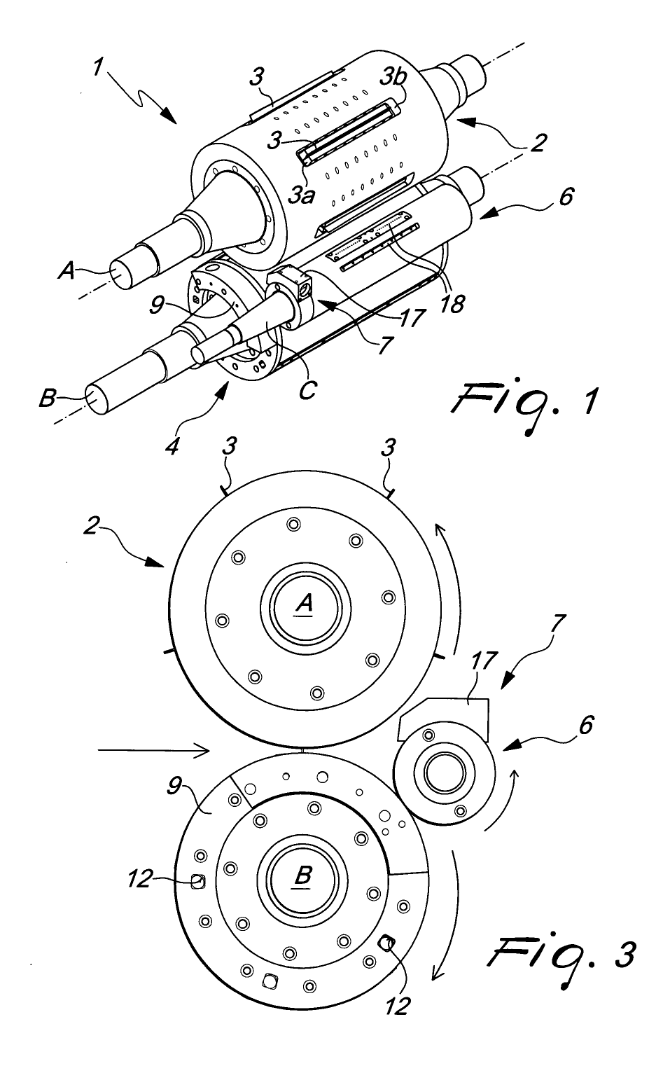

With reference to FIG. 1, the reference numeral 1 generally designates a cutting and folding assembly for sheet products such as tissues, napkins and the like according to the invention.

The cutting and folding assembly is preferably but not exclusively inserted in a line for the production of multiple-ply paper products, such as tissues, napkins and the like.

The products are manufactured starting from one or more continuous multiple-ply ribbons of paper-like material, each of which, not shown for the sake of simplicity in the accompanying figures, reaches the cutting and folding assembly after being folded appropriately longitudinally according to any predefined configuration (for example a Z-shaped or other configuration).

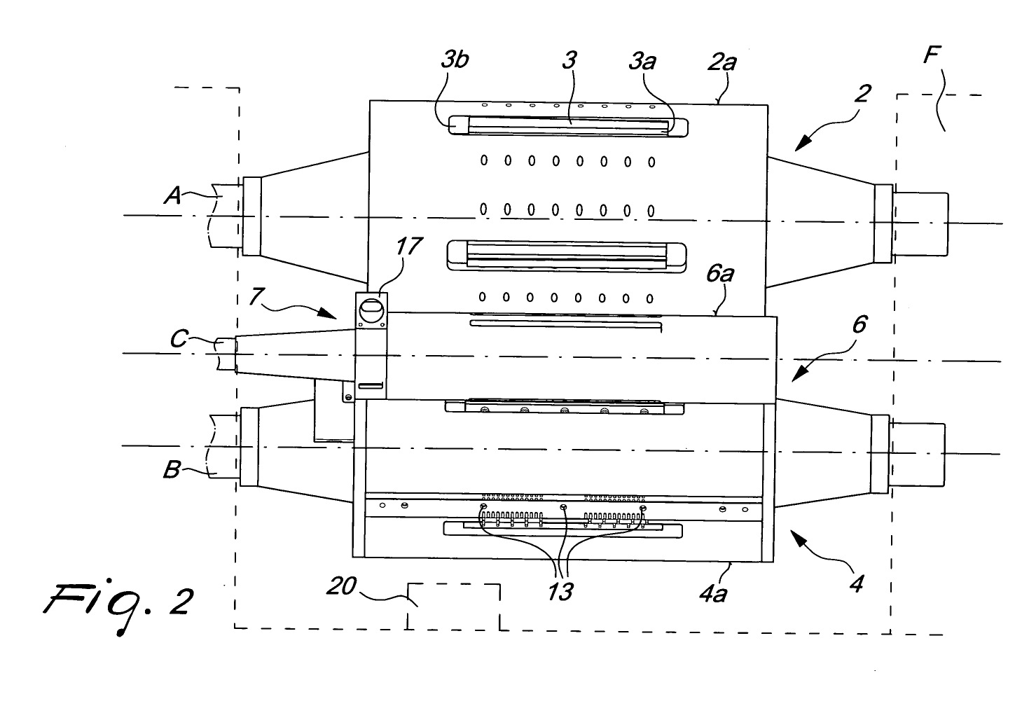

The assembly according to the invention comprises advantageously a first roller, generally designated by the reference numeral 2, which is supported so that it can rotate by fixed parts F of the production line on a first axis A, said fixed parts being schematically shown in FIG. 2; the first roller 2, associated with rotary actuation means (of a known type) controlled by the management and control unit of the production line, is provided, along its outer surface 2a, with a plurality of blades 3 for cutting the continuous ribbon substantially transversely. The cutting blades 3 are fixed to respective elongated supports 3a, which are accommodated in respective surface slots 3b, which are substantially mutually angularly equidistant along the generatrices of the outer surface 2a.

The cutting and folding assembly further comprises a second roller, generally designated by the reference numeral 4, which is supported so that it can rotate by fixed parts of the production line, on a second axis B which is parallel to the axis of the first roller 2 and substantially in contact therewith along a generatrix. The second roller 4, which is also associated with rotary actuation means (of a known type) controlled by the management and control unit of the production line, is provided, on the outer surface 4a, with first retention means for retaining by suction the products cut by the first roller 2, said first means being designated by the reference numeral 5.

The assembly according to the invention further comprises a third folding roller, generally designated by the reference numeral 6, which is supported so that it can rotate by fixed parts of the production line on a third axis C, which is parallel to the first axis A and to the second axis B, substantially in contact with the second roller 4 along a generatrix. The third folding roller 6, associated with rotary actuation means (of a known type) controlled by the management and control unit of the production line, is provided conveniently, on its outer surface 6a, with second retention means, generally designated by the reference numeral 7, for retaining by suction the already-cut products. The third folding roller 6 is further associated with at least one fixed abutment 20, which is rigidly coupled to structural, fixed parts F of the production line. The fixed abutment 20, located substantially proximate to the outer surface 6a of the third roller, is conveniently adapted to provide at least one transverse fold in each of the cut products and can assume any shape and size in relation to the specific applications.

According to the invention, the second roller 4 is advantageously provided with means, generally designated by the reference numeral 8, for generating pressure on the back of each cut product, so as to keep all its plies in contact with the outer surface 6a of the third roller 6 during the formation of said transverse fold.

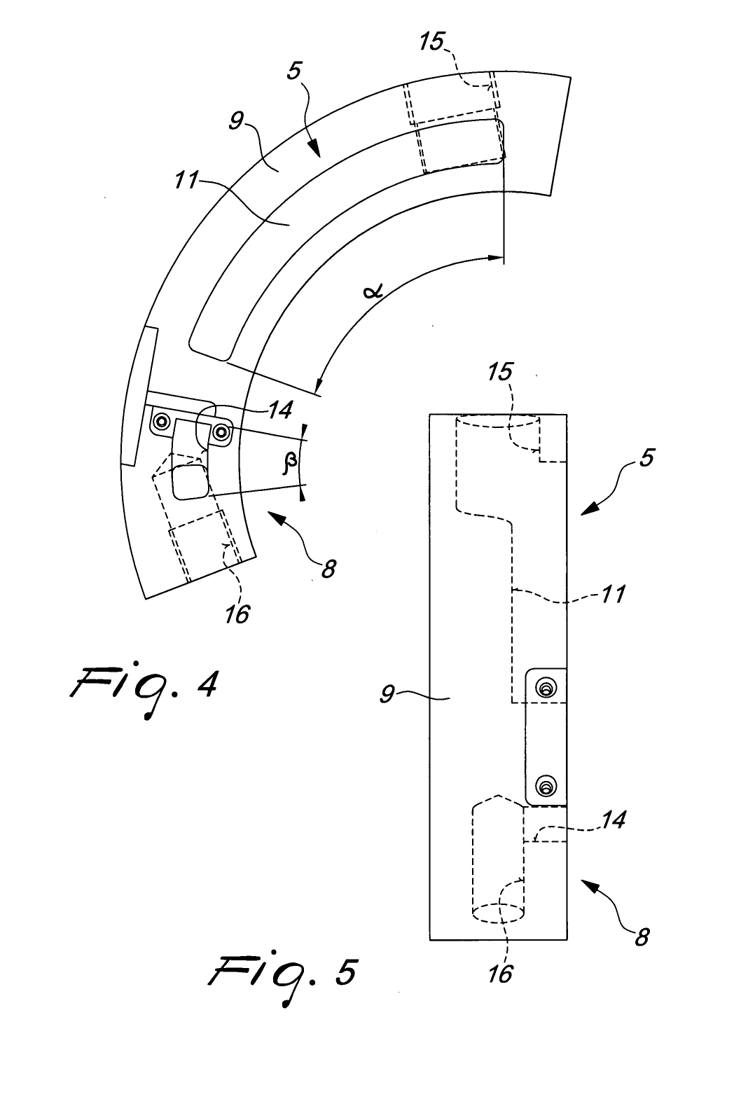

The first suction retention means 5 (FIGS. 4, 5) comprise at least one first valve 9, which is associated with an end face 10 of the second roller 4 and forms at least one vacuum chamber 11, which is substantially shaped like an annular sector with a first angular extension α, which is coupled hermetically to the end face 10 and is connected to vacuum generation means of a type which is substantially known. Correspondingly, the second roller 4 is provided, at the end face 10, with openings 12, which are preferably mutually angularly equidistant and are connected, by means of a plurality of channels 13 which are formed in the body of the second roller 4 and lead to the outer surface 4a, for example in holes arranged along substantially parallel rows.

The pressure generation means 8 (FIGS. 4, 5) comprise at least one pressure chamber 14, which is formed in the body of the first valve 9, is shaped substantially like an annular sector having a second angular extension β, is coupled hermetically to the end face 10 and is connected to pneumatic supply means, of a type which is substantially known and not shown in the figures.

In greater detail, the first valve 9 is substantially shaped like an annular sector and is affected, at its mutually opposite ends, respectively by at least one first threaded hole 15, which is connected to the vacuum chamber 11, and by at least one second threaded hole 16, which is instead connected to the pressure chamber 14. The first threaded hole 15 allows detachable connection to the vacuum generation means, while the second threaded hole 16 allows connection to the pneumatic supply means.

The second suction retention means 7 of the third roller 6 comprise at least one second valve 17, which is associated hermetically with one of the ends of the third roller 6 and is connected to vacuum generation means, not shown for the sake of simplicity in the figures and of a substantially known type. Further, the second valve 17 is connected to openings provided in the third roller 6, which provide access to a plurality of discharge paths 18, which are formed within the body of the third roller 6 and lead to its outer surface 6a.

The operation of the cutting and folding assembly according to the invention is as follows.

The continuous ribbon, already folded longitudinally, is drawn through the first roller 2 and the second roller 4 in the direction indicated by the arrow in FIG. 3, and is cut transversely at regular intervals by the blades 3. The cut products are retained on the surface of the second roller 4 by the first retention means 5 and in particular by way of the suction produced in the vacuum chamber 11. This retention is ensured by pneumatic connection between the vacuum chamber 11 and the openings 12, over an arc of rotation of the second roller 2 which substantially corresponds to the first angular extension α, i.e., the extension required to bring the cut products into contact with the third roller 6. At this point, the action of the first retention means 5 ceases and the action of the second retention means 7 of the third roller 6 begins, making the cut products adhere to its outer surface 6a, through a preset arc of rotation. At the same time, the pressure generation means 8 are actuated (by connection of the pressure chamber 14 to the openings 12) and retain, by way of the action of an air stream produced for an interval which substantially corresponds to a rotation through an angle β of the second roller 2, the cut products with all their plies in contact with the outer surface 6a of the third roller 6. Said air stream in fact acts substantially centrifugally with respect to the second roller 2 and therefore centripetally with respect to the third roller 6, and this allows to avoid any accidental separation or lifting of paper plies from the products in the subsequent production of the transverse fold.

It has thus been shown that the invention achieves the intended aim and object.

The invention thus conceived is susceptible of numerous modifications and variations, all of which are within the scope of the appended claims.

All the details may further be replaced with other technically equivalent elements.

In practice, the materials used, as well as the shapes and dimensions, may be any according to requirements without thereby abandoning the scope of the protection of the appended claims.

The disclosures in Italian Patent Application No. BO2006A000293 from which this application claims priority are incorporated herein by reference.

What is claimed is:

1. A cutting and folding assembly for sheet products of a multiple-ply type, formed starting from at least one continuous ribbon, comprising: at least one first roller, which is rotatably supported for rotation about an axis thereof by fixed parts of a production line; rotary actuation means connected to said at least one first roller; a plurality of blades, provided along an outer surface of said at least one first roller, for cutting a continuous ribbon substantially transversely; at least one second roller, which is rotatably supported for rotation about an axis thereof that is parallel to the axis of said at least one first roller by the fixed parts of the production line; rotary actuation means connected to said at least one second roller, said at least one second roller having an outer surface and being in contact with said at least one first roller along a generatrix; first retention means provided on the outer surface of the at least one second roller for retaining by suction the sheet products cut by said at least one first roller; and at least one third folding roller, which is rotatably supported, for rotation about an axis thereof which is parallel to the axes of said at least one first and second rollers, by the fixed parts of the production line; rotary actuation means connected to said at least one third folding roller, for rotation thereof substantially in contact with said at least one second roller along a generatrix, said at least one third roller having an outer surface, with second retention means provided thereon for retaining the cut products by suction; at least one fixed abutment, located proximate to said at least one second roller and which is adapted to provide at least one transverse fold in each of the cut products; and pressure generation means provided at said at least one second roller for generating pressure on a back part of each of said sheet products so as to keep plies thereof in contact with said at least one third roller during the formation of the transverse fold.

2. The assembly of claim 1, wherein said first suction retention means comprise at least one first valve, which is associated with one end face of said at least one second roller and forms at least one vacuum chamber shaped like an annular sector having a first angular extension, said vacuum chamber being coupled hermetically to said end face and connectable to vacuum generation means, said at least one second roller being provided, on said end face, with openings which are connected to a plurality of channels formed in said at least one second roller, which end at the outer surface thereof.

3. The assembly of claim 2, wherein said pressure generation means comprise at least one pressure chamber, which is provided within a body part of said first valve, said pressure chamber being shaped like an annular sector having a second angular extension, and being coupled hermetically to said end face and being connectable to pneumatic supply means.

4. The assembly of claim 3, wherein said first valve is shaped like an annular sector and is provided, at mutually opposite ends thereof, respectively with at least one first threaded hole, which is connected to said vacuum chamber and is adapted for connection to said vacuum generation means, and by at least one second threaded hole connected to said pressure chamber and is adapted for connection to said pneumatic supply means.

5. The assembly of claim 1, wherein said second suction retention means of said at least one third roller comprise at least one second valve, which is associated hermetically with an end of said at least one third roller and is connected to vacuum generation means and to openings, provided in said at least one third roller, said openings being connected to a plurality of outflow paths which exit at the outer surface of said at least one third roller.

6. The assembly of claim 1, wherein said at least one first roller comprises: a plurality of surface slots, which are provided so as to be mutually angularly equidistant along generatrices thereof; and respective supports, accommodated inside said at least one first roller, for said blades for cutting a continuous ribbon transversely.
